(19) United States
(12) Patent Application Publication
(10) Pub. No.: US 2014/0311683 A1
(43) Pub. Date: Oct. 23, 2014

(54) ANTI-GRAVITY LIQUID EVAPORATOR

(71) Applicant: Jianchen Zhang, Inner Mongolia (CN)

(72) Inventor: Jianchen Zhang, Tongliao, Inner Mongolia (CN)

(21) Appl. No.: 14/357,632

(22) PCT Filed: Nov. 7, 2012
(86) PCT No.: PCT/CN2012/001496

§ 371 Date: May 12, 2014

(30) Foreign Application Priority Data
Nov. 24, 2011 (CN) 201110378088.7

(51) Int. Cl. B01D 1/16

(52) U.S. Cl. CPC B01D 1/16
USPC 159/3

(57) ABSTRACT

An anti-gravity liquid evaporator comprises a tank body (1). The top surface of the tank body (1) is provided with an upper opening (2), the bottom surface of the tank body is provided with a lower opening (7), the inside of the tank is provided with a liquid spray nozzle (3), and plate-shaped dispersion flaps (8) are mounted in the tank body (1), wherein the dispersion flaps (8) are a plurality of horizontal flow boards (9) extending in a horizontal or inclined direction, and the horizontal flow boards (9) are connected by a vertical flow board (10) or an inclined flow board (16) that is inclined.

This application is the U.S. national phase of International Application No. PCT/CN2012/001496 filed on 7 Nov. 2012 which designated the U.S. and claims priority to Chinese Application Nos. CN201110378088.7 filed on 24 Dec. 2011, the entire contents of each of which are hereby incorporated by reference.

### FIELD OF THE INVENTION

The present invention relates to a device, and in particular to, an anti-gravity liquid evaporator.

### BACKGROUND OF THE INVENTION

Impurities in liquid substances such as oil and fat need to be removed usually during a machining process, wherein gross grain impurities are mostly separated through a filtering method, impurities having a large specific weight are mostly separated through a precipitation method, and some impurities that are easily gasified, are mostly separated through a fractional distillation or evaporation manner. The fractional distillation manner is to heat materials to make a certain substance reach the boiling point and thus be separated, which requires to consume a lot of thermal energy and will generate negative influences on quality of some products. The evaporation manner is a process of volatilizing a certain substance via the surface of the material, only requiring to make the material dispersed and acquire a surface area as large as possible, and be supplemented by steam and negative pressure measures, which has low energy consumption, has no negative influences on quality of products, and thus is widely applied in practice. However, the present liquid evaporation devices are not perfect yet, have the defects of big and high volume, low production efficiency, poor cleaning efficiency, and the like, and need to be improved urgently. Taking edible oil for example, virgin oil and fat contain moisture and multiple peculiar smell impurities that are easily volatilized, which need to be handled by using a liquid evaporation device. According to the existing evaporation device for edible oil deacidification and deodorization, a plurality of risers are arranged in the tank body; hot gases are pumped into the risers from bottom to top, and oil is slowly filled in the tank; when an oil level exceeds the upper opening of the riser, the oil and fat enter the inside of the riser, and downwards flows out the tank body along the wall of the riser. Peculiar smell substances are separated with the rising of the hot gases. The disadvantages of device are: the liquid depends on gravity to go downwards, and a rate of flow is faster and faster, which not only requires to increase the height of the device, but also reduces the evaporation performance with the increasing of the rate of flow, and thus has an not ideal separation effect. Therefore, people divide the inside of the tank body into multiple-layer space so as to equip the risers by layer, so that the oil and fat stops flowing downwards under a lower speed and enters a bottom layer to flow again. In this way, although some effects are acquired, the liquid does not get rid of a manner of going downwards vertically yet, and the influence of the gravity acceleration is still very big; moreover, an area for the liquid to flow downwards is also very small and the operating performance is also low; particularly, the structure of the device is more complicated, the volume of the device is also larger, and the cost is always high.

### SUMMARY OF THE INVENTION

The present invention aims at providing a separation device for liquid volatile impurities, which has the advantages of stronger impurity separation capacity, smaller volume, lower cost, less energy consumption and higher working efficiency.

The foregoing objective is implemented through the following technical solution: an anti-gravity liquid evaporator, comprises a tank body, wherein the top surface of the tank body is provided with an upper opening, the bottom surface of the tank body is provided with a lower opening, and the inside of the tank is provided with a liquid spray nozzle. The anti-gravity liquid evaporator is further characterized in that: plate-shaped dispersion flaps are mounted in the tank body. The dispersion flaps are a plurality of horizontal flow boards extending in a horizontal or inclined direction, and the horizontal flow boards or the inclined flow board are connected by a vertical flow board or an inclined flow board that is inclined.

An included angle alpha between the horizontal flow boards and a horizontal line is no more than 5 degrees.

The plurality of horizontal flow boards are mutually parallel and every two adjacent horizontal flow boards are all connected end to end by the inclined flow board to form a “Z”-shaped structure.

The plurality of inclined flow boards are connected end to end and inflected repeatedly.

Bent parts of the dispersion flaps are smooth transition surfaces.

The vertical flow boards are respectively an inner wall of the tank body, the two sides of a sleeve in the tank and the surface of a stand column in the tank, wherein the horizontal flow boards are annular, respectively fixed surrounding the inner wall of the tank body, the two sides of the sleeve in the tank and the surface of the stand column in the tank, and are mutually interlaced and alternated.

The horizontal flow boards installed on the sleeve in the tank, the stand column and the surface are of an integrated structure, and are hung in the tank body by a flexible sling.

The horizontal flow boards are a plurality of sheets jointed out from one side of the vertical flow boards, the middle lines of the horizontal flow boards are horizontal, and both the top surface and the bottom surface of the horizontal flow boards are inclined certainly.

The upper opening of the tank body is opposite to an intake port of a vacuum apparatus, and the lower opening of the tank body is opposite to a steam transportation pipe

The liquid spray nozzle is connected with a liquid transportation pipe, and a flow controller and a gas-liquid mixing chamber are arranged on the liquid transportation pipe.

The present invention has the advantageous effects that: Liquid in the anti-gravity liquid evaporator mainly flows along the surfaces of the horizontal or inclined plates, reducing the velocity of falling and significantly increasing the opportunities for volatilized matter to be released. Particularly, the liquid may rely on molecular attraction, and overcome the action of gravity to flow on the lower surfaces of the dispersion flaps in the horizontal or inclined direction, resulting in an extremely excellent dispersion effect. Therefore, the anti-gravity liquid evaporator can achieve a satisfied evaporation effect under the circumstances of simplified structure, reduced height and energy consumption, unaffected liquid quality, and greatly reduced treatment cost, and is particularly applicable to such operations as deacidification and deodorization of edible oil, purification of petroleum oil as well as extraction of multiple liquid volatile ingredients.

### BRIEF DESCRIPTION OF DRAWINGS

FIG. 1 is a front view of a first embodiment;

FIG. 2 is an A-A section vertical view of the first embodiment;

FIG. 3 is a working principle schematic view of the first embodiment;

FIG. 4 is a front view of a second embodiment;

FIG. 5 is a front view of a third embodiment;

FIG. 6 is a front view of a fourth embodiment;

FIG. 7 is a working principle schematic view of a fifth embodiment;

FIG. 8 is an amplified front view of a dispersion flap of the fifth embodiment;

FIG. 9 is an assembly schematic view of the dispersion flap of the fifth embodiment;

FIG. 10 is a partial amplified schematic view of a sixth embodiment;

FIG. 11 is a front view of a dispersion flap of a seventh embodiment;

FIG. 12 is an assembly front view of the dispersion flap of the seventh embodiment;

FIG. 13 is a front view of a dispersion flap of an eighth embodiment; and

FIG. 14 is a front view of the eighth embodiment.

It can be seen in the FIGs that: tank body 1, upper opening 2, liquid spray nozzle 3, hot gas pipe 4, liquid transportation pipe 5, gas-liquid mixing chamber 6, lower opening 7, dispersion flaps 8, horizontal flow boards 9, vertical flow board 10, vacuum apparatus 11, steam pipe 12, sleeve 13, stand column 14, sling 15, inclined flow board 16 and transition surface 17.

### DETAILED DESCRIPTION OF THE EMBODIMENTS

The general concept of the present invention is to use horizontal liquid flowing to replace vertical liquid flowing; particularly, to make the liquid overcome the effect of gravity, and rely on interior molecular attraction to move horizontally at the lower side of a plane or incline, thus making the liquid dispersed more evenly, and evaporating volatile matters more thoroughly.

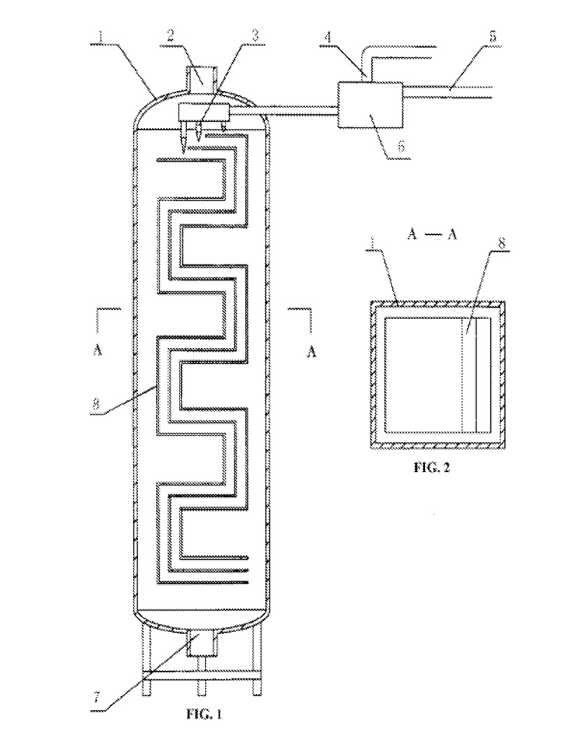

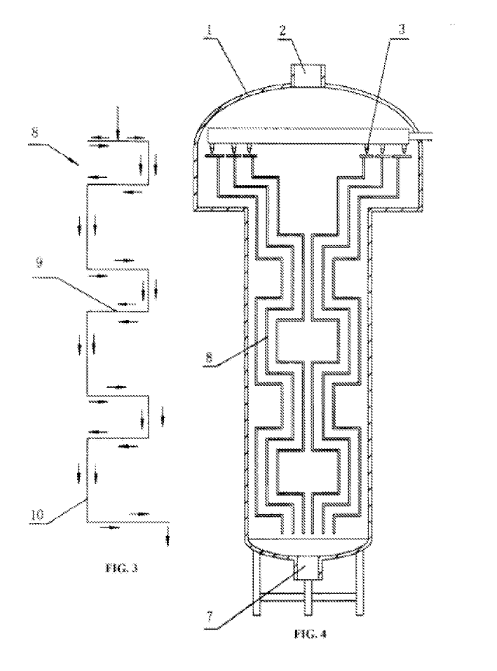

The first embodiment: as shown in FIG. 1 and FIG. 2, the evaporator is provided with a thin and high hollow tank body 1, wherein the transverse section of the tank body 1 can be one of such shapes as rectangle, diamond, round or oval. The top of the tank body 1 is provided with an upper opening 2, and the lower end of the tank body is provided with a lower opening 7. The upper opening 2 can be connected with a vacuum apparatus, and the lower opening 7 is a discharge opening, and is opposite to a steam pipe. A liquid spray nozzle 3 is arranged at the upper part of the tank body 1. The liquid spray nozzle 3 is communicated with a liquid transportation pipe 5. A gas-liquid mixing chamber 6 is installed on the liquid transportation pipe 5. Liquid enters the liquid-gas mixing chamber 6 and is mixed with hot gases inputted in a hot gas pipe 4, so that the liquidity is enhanced; afterwards, the liquid is quantitatively pumped into the liquid spray nozzle 3 under the control of a flow controller, and sprayed to the inside of the tank body 1. The evaporator has the characteristics that: Dispersion flaps 8 formed by bending sheets are filled in the tank body 1. The dispersion flaps 8 can be bent through multiple manners. In the Fig, only one manner of repeatedly inflecting horizontally and vertically is illustrated. We call horizontal sheets as horizontal flow boards 9, and call vertical sheets as vertical flow boards 10, wherein a plurality of horizontal flow boards 9 opposite up and down are connected by a plurality of vertical flow boards 10 to form a row of dispersion flaps 8. The quantity of the dispersion flaps 8 is at least one row. In the FIG. 1, three rows are illustrated. Of course, the quantity can be more. The dispersion flaps 8 may be fixed in the tank body through multiple support manners.

A flowing process of liquid on the dispersion flaps 8 can be seen in FIG. 3: the liquid arriving the top surfaces of the dispersion flaps 8 flow horizontally to the surroundings, and flows downwards at the edge due to the effect of gravity. However, because the amount of the liquid is smaller, the liquid cannot directly fall off due to the gravitational force effect between the liquid and the surfaces of the boards as well as the gravitational force effect between molecules inside the liquid; instead, the liquid flows horizontally along the bottom surfaces of the dispersion flaps; sometimes few of the liquid drops onto the surface of next layer of boards and continues to flow horizontally; and most of the liquid flows to the vertical flow boards 10 and then flows downwards. During a process of repeatedly inflecting, the gravitational acceleration after being accumulated transitorily when moving longitudinally, immediately enters a horizontal flowing process and is reduced to 0; and micro kinetic energy just accumulated becomes a power to push the liquid to disperse slowly and is quickly consumed in friction. Apparently, in the case of determined liquid viscosity and flow, the liquid can be continuously dispersed and recombined on the surfaces of the boards to form a new thin layer repeatedly by adopting reasonable structural parameters; under the effect of reverse steams, easy volatile matters in the liquid will separate from the colligation of the molecules and isolate.

In order to validate the correctness of the foregoing theories, multiple contrast tests have been performed since 2008. Tests on deacidification and deodorization of sunflower oil and soybean oil have acquired relatively complete data. The data shows that the device when being compared with the existing riser type multi-layer volatilization tank in the case of same treating capacity and cleaning index, the height is reduced by more than 50%, the steam consumption is reduced by more than 40%, the upper limit cleaning index is far higher than that of the contrast device, the product grade is improved obviously, the device cost is greatly reduced, and the device obtains a good reputation from relevant experts and scholars.

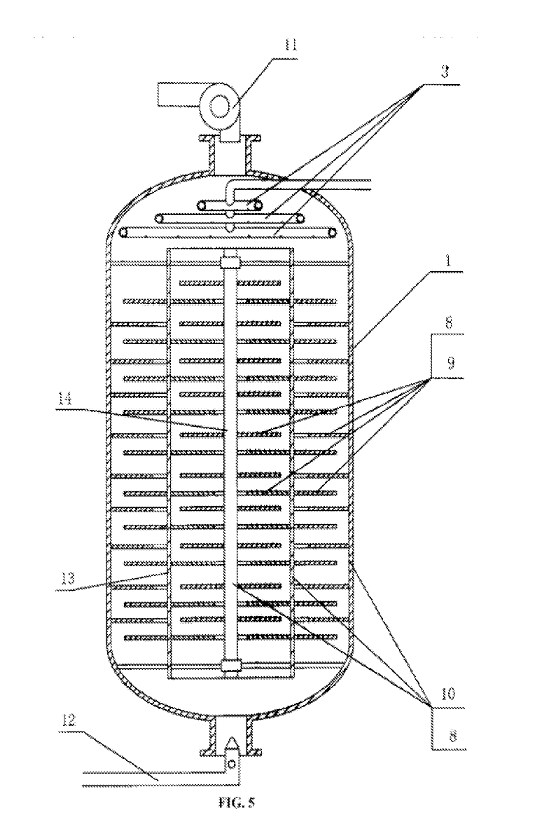

The second embodiment: as shown in FIG. 4, the tank body 1 is big and round in the top, and is small and square in the bottom; the dispersion flaps 8 inside the tank body are formed by the horizontal flow boards 9 and the vertical flow boards 10, and divided in two groups. The upper ends of the dispersion flaps 8 are abreast; the horizontal flow boards 9 and the vertical flow boards 10 of the dispersion flaps 8 in the top are in a step shape, and the horizontal flow boards and the vertical flow boards of the dispersion flaps in the bottom are in a repeatedly inflected shape.

The third embodiment: as shown in FIG. 5, the vacuum apparatus 11 is installed on the upper opening of the tank body 11; the steam pipe 12 is installed on the lower opening of the tank body; the dispersion flaps 8 in the tank include three forms, wherein one is multi-layer annular horizontal flow boards 9 installed on the inner wall of the tank body 1, another is a plurality of annular horizontal flow boards 9 installed inside and outside a sleeve 13 which is sheathed inside the tank body 1, and the other is a plurality of horizontal flow boards 9 installed surrounding a stand column 14 which is arranged just in the middle of the inside of the tank body. Adjacent two rows of horizontal flow boards 9 are mutually interlaced and alternated. The inner wall of the tank body 1, the sleeve 13 and the stand column 14 in the tank are all equivalent to vertical flow boards 10. Liquid can repeatedly inflect and flow on the top and bottom planes of the horizontal flow boards 9 and on the vertical flow boards 10. This structure is more suitable for a cylinder-shaped tank body 1, which can better utilize the space of the inner wall and surroundings thereof of the tank body, increase the working area and improve the operating efficiency.

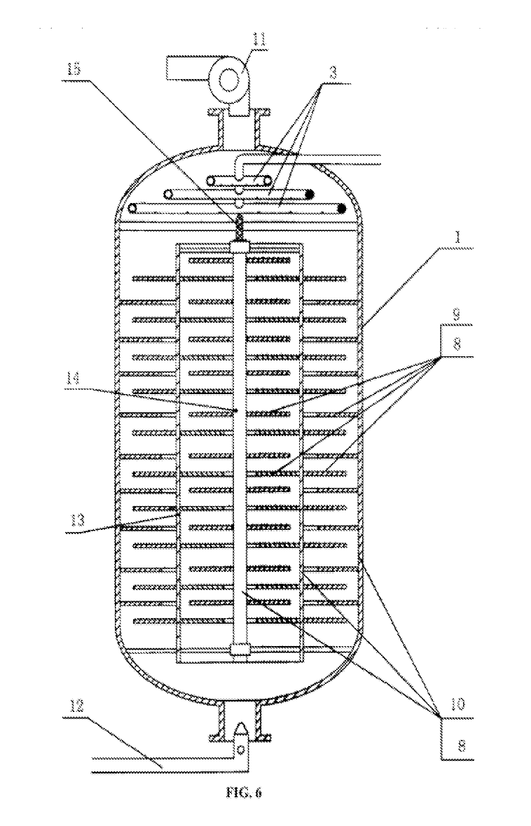

The fourth embodiment: the device shown in FIG. 6 is basically the same as that in the third embodiment. The difference is that the internal sleeve 13, the stand column 14 and the horizontal flow boards 9 on the top surface are an entirety, which are hung inside a tank body 1 through the flexible sling 15, can adjust positions automatically, keep the flatness of the dispersion flaps 8, and have a lower requirement on horizontal installation.

The fifth embodiment: the dispersion flaps 8 shown in FIG. 7 are relatively similar to that in the first embodiment, however, the horizontal flow boards therein are certainly inclined and are called as inclined flow boards 16; the inclined direction of the inclined flow boards 16 are consistent with the flowing direction of the liquid; that is along the flowing direction of the liquid, the inclined flow boards 16 are slightly reduced, and an included angle alpha between the boards and the horizontal line is no more than 5 degrees and is better to be 1-2 degrees.

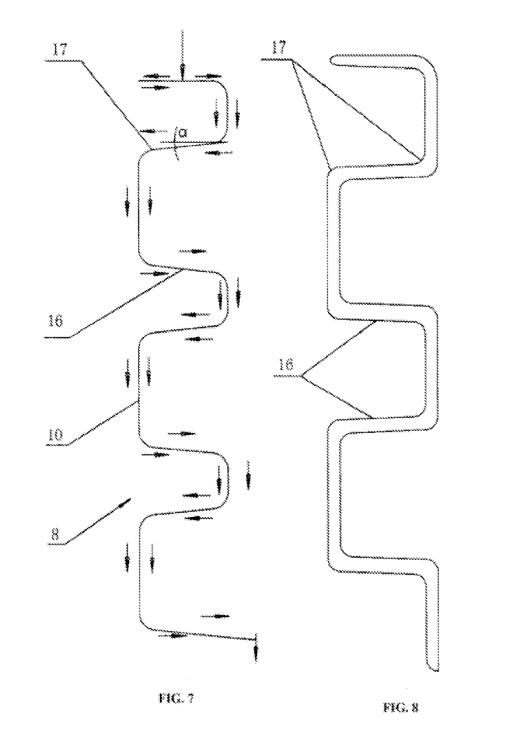

In addition, it can be seen from FIG. 8 that the cross part of the inclined flow board 16 and the vertical flow board 10 is a round corner, which is just a smooth transition surface 17.

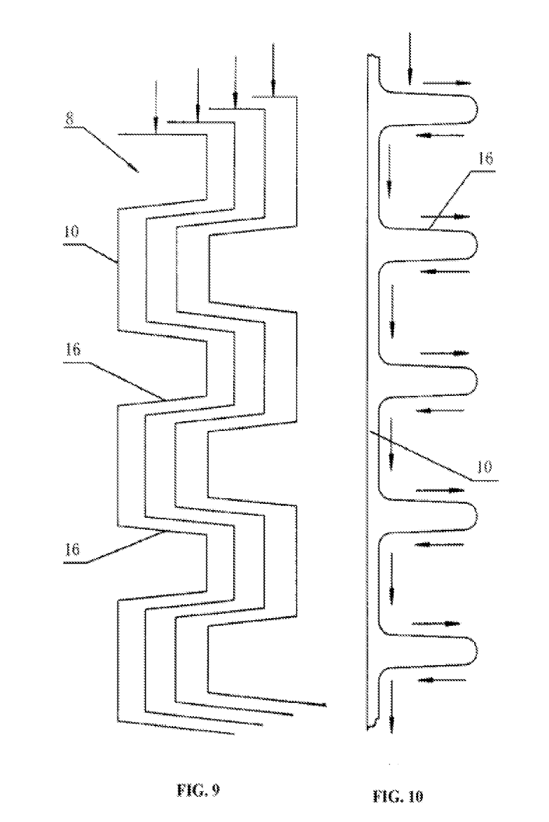

FIG. 9 introduces a combination state of interlacing and alternating a plurality of dispersion flaps 8, wherein this mechanism is relatively suitable for a tank body 1 having a rectangle transverse section.

Test shows that the foregoing connected manner of smooth transition between the inclined flow board 16 and the vertical flow board 10 has important effect on improving the flow state of the liquid. The liquid not only can flow evenly along the top surface of the inclined flow board 16, but also can smoothly flow to the other end on the bottom surface of the inclined flow board 16, and then flows downwards through the vertical flow board 10, and the effect is more ideal.

The sixth embodiment: The dispersion flaps 8 shown in FIG. 10 are a plurality of sheets jointed out from one side of the vertical flow board 10. The middle lines of the sheets are horizontal, which shall belong to the horizontal flow boards 9, however the top and bottom surfaces have certain inclination, which shall belong to the inclined flow board 16. The sheets are combination types of the horizontal flow boards 9 and the inclined flow boards 16. This structure is relatively suitable for a connecting structure of the inner wall of the tank body 1 and the dispersion flaps 8.

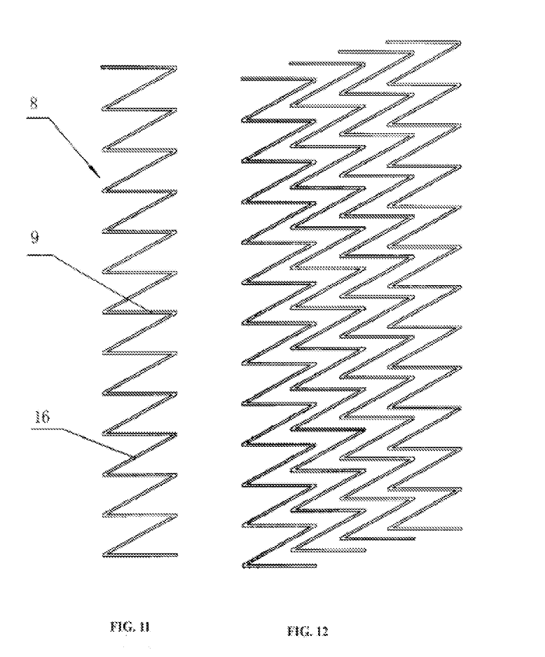

The seventh embodiment: the dispersion flaps 8 shown in FIG. 11 are structure forms of jointing the horizontal flow boards 9 and the inclined flow boards 16. The dispersion flaps 8 have a plurality of horizontally arranged horizontal flow boards 9. Every two adjacent horizontal flow boards 9 are all connected end to end by the inclined flow board 16 to form a “Z”-shaped structure. This structure can further reduce the vertical moving process of the liquid, so that the dispersivity of the liquid is better. This structure is especially convenient for sheathing a plurality of flaps as shown in FIG. 12. Since the sheathed dispersion flaps 8 are the same, the structure is convenient for mass production, and enhances the feasibility of the technical solution.

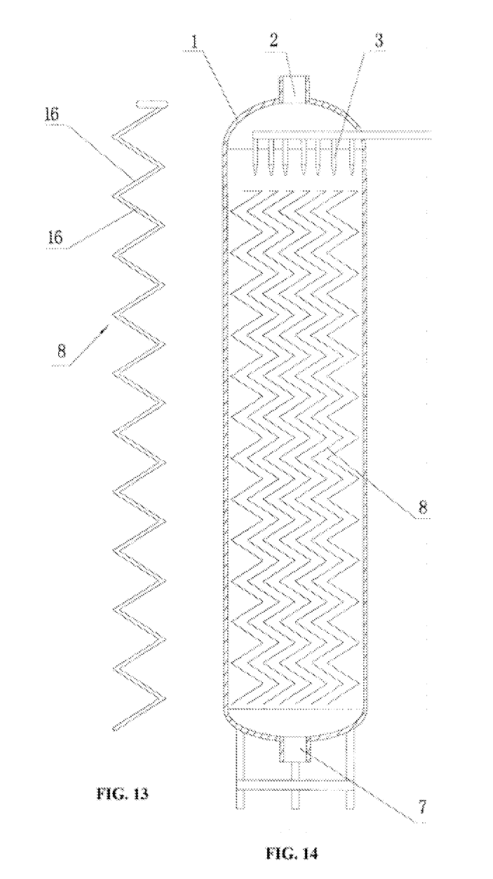

The eighth embodiment: the dispersion flaps 8 shown in FIG. 13 are formed by a plurality of inclined flow boards 16 that are connected end to end and repeatedly inflected, and installed inside the tank body 1 according to the form of FIG. 14. The liquid at the two surfaces of the inclined flow boards 16 can flow very uniformly and smoothly, and the boards are very convenient to manufacture. Therefore, this structure form is very easy to spread and popularize.

What is claimed is:

1. An anti-gravity liquid evaporator, comprising a tank body (1), wherein the top surface of the tank body (1) is provided with an upper opening (2), the bottom surface of the tank body is provided with a lower opening (7), and the inside of the tank is provided with a liquid spray nozzle (3); further characterized in that: plate-shaped dispersion flaps (8) are mounted in the tank body (1), the dispersion flaps (8) are a plurality of horizontal flow boards (9) extending in a horizontal or inclined direction, and the horizontal flow boards (9) are connected by a vertical flow board (10) or an inclined flow board (16) that is inclined.

2. The anti-gravity liquid evaporator according to claim 1, wherein an included angle alpha between the horizontal flow boards (9) and a horizontal line is no more than 5 degrees.

3. The anti-gravity liquid evaporator according to claim 1, wherein the plurality of horizontal flow boards (9) are mutually parallel, and every two adjacent horizontal flow boards (9) are all connected end to end by the inclined flow board (16) to form a “Z”-shaped structure.

4. The anti-gravity liquid evaporator according to claim 1, wherein the plurality of inclined flow boards (16) are connected end to end and inflected repeatedly.

5. The anti-gravity liquid evaporator according to claim 1, wherein bent parts of the dispersion flaps (8) are smooth transition surfaces (17).

6. The anti-gravity liquid evaporator according to claim 1, wherein the vertical flow boards (10) are respectively an inner wall of the tank body (1), the two sides of a sleeve (13) in the tank and the surface of a stand column (14) in the tank, wherein the horizontal flow boards (9) are annular, respectively fixed surrounding the inner wall of the tank body (1), the two sides of the sleeve (13) in the tank and the surface of the stand column (14) in the tank, and are mutually interlaced and alternated.

7. The anti-gravity liquid evaporator according to claim 6, wherein the horizontal flow boards (9) installed on the sleeve (13) in the tank, the stand column (14) and the surface are of an integrated structure, and are hung in the tank body (1) by a flexible sling (15).

8. The anti-gravity liquid evaporator according to claim 1, wherein the horizontal flow boards (9) are a plurality of sheets jointed out from one side of the vertical flow boards (10), the middle lines of the horizontal flow boards (9) are horizontal, and both the top surface and the bottom surface of the horizontal flow boards (9) are inclined.

9. The anti-gravity liquid evaporator according to claim 1, wherein the upper opening (2) of the tank body (1) is opposite to an intake port of a vacuum apparatus (11), and the lower opening (7) of the tank body (1) is opposite to a steam transportation pipe (12).

10. The anti-gravity liquid evaporator according to claim 1, wherein the liquid spray nozzle (3) is connected with a liquid transportation pipe (5), and a flow controller and a gas-liquid mixing chamber (6) are arranged on the liquid transportation pipe (5).
